(19) United States
(12) Patent Application Publication
(10) Pub. No.: US 2025/0191572 A1
(43) Pub. Date: Jun. 12, 2025

(54) ELECTRONIC DEVICE FOR OBTAINING SYNTHESIZED SPEECH BY CONSIDERING EMOTION AND CONTROL METHOD THEREFOR

(71) Applicant: Samsung Electronics Co., Ltd., Suwon-si (KR)

(72) Inventors: Heejin CHOI, Suwon-si (KR); Jaesung BAE, Suwon-si (KR); Jounyeop LEE, Suwon-si (KR); Seongkyu MUN, Suwon-si (KR); Jihwan LEE, Suwon-si (KR); Kihyun CHOO, Suwon-si (KR)

(21) Appl. No.: 19/058,913

(22) Filed: Feb. 20, 2025

Related U.S. Application Data
(63) Continuation of application No. PCT/KR2023/016677, filed on Oct. 25, 2023.

(30) Foreign Application Priority Data
Oct. 25, 2022 (KR) 10-2022-0138639

(51) Int. Cl. G10L 13/027; G10L 13/08

(52) U.S. Cl. CPC G10L 13/027; G10L 13/08

(57) ABSTRACT

An electronic device is provided. The electronic device includes memory storing one or more computer programs and a plurality of token sets corresponding to respective multiple emotions, and one or more processors communicatively coupled to the memory, wherein the one or more computer programs include computer-executable instructions that, when executed by the one or more processors individually or collectively, cause the electronic device to, based on receiving a reference speech, identify an emotion corresponding to the reference speech among the plurality of emotions, obtain a token set corresponding to the identified emotion from among the plurality of token sets stored in the memory, input information on the reference speech and the obtained token set into a style encoder and obtain style information for outputting a synthesized speech of the identified emotion, based on a text being input, input the text into a decoder obtained on the basis of the style information and obtain a synthesized speech corresponding to the text, and output the synthesized speech corresponding to the text.

### CROSS-REFERENCE TO RELATED APPLICATION(S)

This application is a continuation application, claiming priority under § 365(c), of an International application No. PCT/KR2023/016677, filed on Oct. 25, 2023, which is based on and claims the benefit of a Korean patent application number 10-2022-0138639, filed on Oct. 25, 2022, in the Korean Intellectual Property Office, the disclosure of which is incorporated by reference herein in its entirety.

### BACKGROUND

### 1. Field

The disclosure relates to an electronic device and a control method. More particularly, the disclosure relates to an electronic device that obtains a synthesized speech to which an emotion is reflected, and a control method therefor.

### 2. Description of Related Art

A speech synthesis technology is a technology of synthesizing a speech corresponding to a text, and is being utilized in many areas recently.

As deep learning technologies are utilized, there have been many improvements in the quality of synthesized speeches, but there is still a lot of technical insufficiency in outputting a synthesized speech to which liveliness is reflected.

In particular, there is a problem that, while a synthesized speech according to a neutral emotion gives little awkwardness or sense of unfamiliarity, a synthesized speech to which an angry or a pleasant emotion is reflected is mechanical and unnatural, and thus gives awkwardness.

Even in the case of synthesized speeches corresponding to the same text, their meaning may be different according to whether an emotion is reflected, and thus there has been a demand for a speech synthesis technology for obtaining a synthesized speech to which an emotion is appropriately reflected in consideration of utilizability, etc., and which gives a feeling as if a person actually uttered it.

However, it is difficult to obtain training data which corresponds to each of multi languages, and to which a plurality of emotions are reflected, and there has been a demand for a speech synthesis technology for appropriately outputting a synthesized speech which corresponds to a text and to which an emotion was transferred in a multi-language environment.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for obtaining synthesized speech by considering emotion and control method therefor.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs and a plurality of token sets corresponding to each of a plurality of emotions, and one or more processors communicatively coupled to the memory, wherein the one or more computer programs include computer-executable instructions that, when executed by the one or more processors individually or collectively, cause the electronic device to, based on receiving a reference speech, identify an emotion corresponding to the reference speech among the plurality of emotions, obtain a token set corresponding to the identified emotion among the plurality of token sets stored in the memory, input information on the reference speech and the obtained token set into a style encoder and obtain style information for outputting a synthesized speech of the identified emotion, and based on a text being input, input the text into a decoder obtained on the basis of the style information and obtain a synthesized speech corresponding to the text, and output the synthesized speech corresponding to the text.

In accordance with another aspect of the disclosure, a control method performed by an electronic device is provided. The control method includes, based on receiving a reference speech, identifying an emotion corresponding to the reference speech among a plurality of emotions, obtaining a token set corresponding to the identified emotion among token sets corresponding to each of the plurality of emotions, inputting information on the reference speech and the obtained token set into a style encoder and obtaining style information for outputting a synthesized speech of the identified emotion, based on a text being input, inputting the text into a decoder obtained on the basis of the style information and obtaining a synthesized speech corresponding to the text, and outputting the synthesized speech corresponding to the text.

One or more non-transitory computer-readable storage media storing one or more computer programs including computer-executable instructions that, when executed by one or more processors of an electronic device individually or collectively, cause the electronic device to perform operations are provided. The operations include based on receiving a reference speech, identifying an emotion corresponding to the reference speech among a plurality of emotions, obtaining a token set corresponding to the identified emotion among token sets corresponding to each of the plurality of emotions, inputting information on the reference speech and the obtained token set into a style encoder and obtaining style information for outputting a synthesized speech of the identified emotion, based on a text being input, inputting the text into a decoder obtained on the basis of the style information and obtaining a synthesized speech corresponding to the text, and outputting the synthesized speech corresponding to the text.

According to an embodiment of the disclosure for achieving the aforementioned purpose, in a computer-readable recording medium including a program executing a control method for an electronic device, the control method for an electronic device includes, based on receiving a reference speech, identifying an emotion corresponding to the reference speech among a plurality of emotions, obtaining a token set corresponding to the identified emotion among token sets corresponding to each of the plurality of emotions, inputting information on the reference speech and the obtained token set into a style encoder and obtaining style information for outputting a synthesized speech of the identified emotion, and based on a text being input, inputting the text into a decoder obtained on the basis of the style information and obtaining a synthesized speech corresponding to the text, and outputting the synthesized speech corresponding to the text.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for illustrating an electronic device that obtains a synthesized speech through a style encoder and a decoder according to an embodiment of the disclosure;

FIG. 2 is a block diagram illustrating a configuration of an electronic device according to an embodiment of the disclosure;

FIG. 3 is a diagram for illustrating style information obtained through a style encoder according to an embodiment of the disclosure;

FIG. 4 is a diagram for illustrating a style encoder that outputs style information by using a token set corresponding to an emotion and a language token according to an embodiment of the disclosure;

FIG. 5 is a diagram for illustrating a style encoder that outputs style information by using token sets corresponding to each of a plurality of emotions, a speaker token, a language token, and a residual token according to an embodiment of the disclosure;

FIG. 6 is a diagram for illustrating training of a style encoder according to an embodiment of the disclosure;

FIG. 7 is a diagram for illustrating a plurality of sample reference speeches and a synthesized speech according to an embodiment of the disclosure;

FIG. 8 is a diagram for illustrating a synthesized speech obtained through a decoder in a multi-language environment according to an embodiment of the disclosure;

FIG. 9 is a diagram for illustrating a decoder that outputs a synthesized speech including an utterance feature of a user according to an embodiment of the disclosure;

FIG. 10 is a diagram for illustrating fine-tuning of a decoder according to an embodiment of the disclosure;

FIG. 11 is a diagram for illustrating a decoder that outputs a synthesized speech in consideration of a speaker to be synthesized after fine-tuning of the decoder, and a speaker token corresponding to each of a plurality of sample reference speeches according to an embodiment of the disclosure; and

FIG. 12 is a flow chart for illustrating a control method for an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the other element, and the case where the one element is coupled to the other element through still another element (e.g.: a third element).

Also, singular expressions include plural expressions, as long as they do not obviously mean differently in the context. In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor (not shown), except “a module” or “a part” that needs to be implemented as specific hardware.

Also, in this specification, the term “user” may refer to a person who uses an electronic device or a device using an electronic device (e.g.: an artificial intelligence electronic device).

Hereinafter, an embodiment of the disclosure will be described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

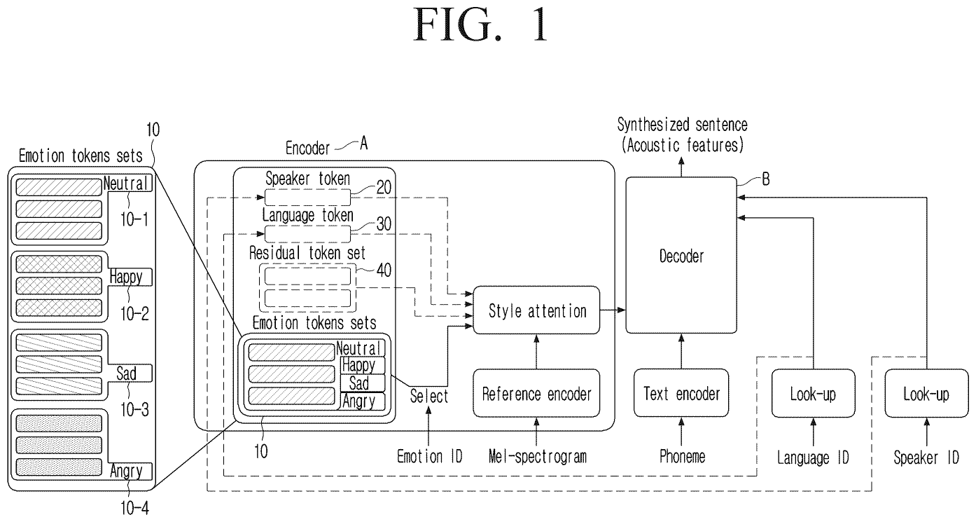

FIG. 1 is a diagram for illustrating an electronic device that obtains a synthesized speech through a style encoder and a decoder according to an embodiment of the disclosure.

An electronic device 100 according to an embodiment of the disclosure may indicate a speech synthesis (or a text-to-speech (TTS)) device including a style encoder A, a text encoder, and a decoder B.

The speech synthesis device may, when a text is input, synthesize a speech corresponding to the input text, and output it.

A speech output by a conventional speech synthesis device (e.g., a synthesized speech) had a limitation that it is mechanical and relatively monotonous compared to a human's real speech. For example, a human's real speech includes a prosodic feature to which the speaker's emotion is reflected, but a speech output by a conventional speech synthesis device merely converts a text into a speech, and does not include a prosodic feature to which an emotion is reflected, and thus there is a limitation in providing naturalness or liveliness.

According to an embodiment, a prosody may include a tone, an accent, a rhythm, etc., and a prosodic feature may include a pitch (e.g., high and low), a length (e.g., speed), a size (e.g., strong and weak), etc. of a sound.

The electronic device 100 according to an embodiment of the disclosure may synthesize a speech which corresponds to a text, and to which an emotion is reflected by using the style encoder A and the decoder B, and output the speech.

According to an embodiment, the electronic device 100 may obtain style information corresponding to an emotion to be reflected to a speech synthesized by the decoder B by using the style encoder A, and reflect (or, synthesize) the emotion according to the style information to a speech corresponding to a text by using the decoder B, and obtain (or, output) a synthesized speech.

According to an embodiment, the style information may also be referred to as a style vector, but it will be generally referred to as style information hereinafter, for the convenience of explanation.

The electronic device 100 according to an embodiment of the disclosure may include a token set 10 corresponding to each of a plurality of emotions.

If a reference speech is received, the electronic device 100 according to an embodiment may identify an emotion corresponding to the reference speech among a plurality of emotions. However, this is merely an example, and the disclosure is not limited thereto. For example, the electronic device 100 may receive an emotion identifier (ID), and identify an emotion corresponding to the emotion ID among a plurality of emotions.

The electronic device 100 according to an embodiment may input a token set corresponding to the identified emotion and the reference speech into the style encoder A, and obtain style information for obtaining a synthesized speech to which the identified emotion is reflected, and which has a similar style to the reference speech through the decoder B.

The electronic device 100 according to an embodiment may input a text and the style information into the decoder B, and synthesize and output a speech which corresponds to a text, and to which an emotion is reflected, and which has a similar style to the reference speech.

For example, each person has a different style of uttering a speech to which a specific emotion (e.g., anger) is reflected, and thus the decoder B may synthesize and output a speech which has a similar style (e.g., an utterance style) to a reference speech, and to which a specific emotion is reflected.

For example, even if each of a plurality of people utters a speech by reflecting the same emotion, their utterance styles vary according to the sex, the age, the region, the oral structure, etc., and accordingly, if a reference speech and a token set corresponding to an identified emotion are input, a style attention of the style encoder A may output style information for synthesizing a speech which has a similar style to the reference speech, and to which the emotion is reflected, and the decoder B may synthesize and output a speech which has a similar style to the reference speech, and to which the identified emotion is reflected based on the style information.

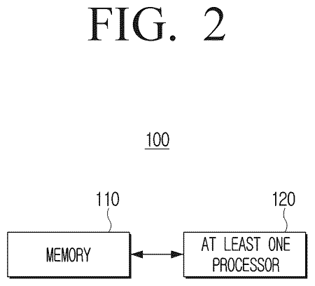

FIG. 2 is a block diagram illustrating a configuration of an electronic device according to an embodiment of the disclosure.

Referring to FIG. 2, the electronic device 100 includes memory 110 and at least one processor 120.

The memory 110 according to an embodiment may store data necessary for various embodiments.

The memory 110 may be implemented in the form of memory embedded in the electronic device 100, or implemented in the form of memory that can be attached to or detached from the electronic device 100 according to the use of stored data. For example, in the case of data for driving the electronic device 100, the data may be stored in memory embedded in the electronic device 100, and in the case of data for an extended function of the electronic device 100, the data may be stored in memory that can be attached to or detached from the electronic device 100. Meanwhile, in the case of memory embedded in the electronic 100, the memory may be implemented as at least one of volatile memory (e.g.: dynamic random access memory (RAM) (DRAM), static RAM (SRAM), or synchronous dynamic RAM (SDRAM), etc.) or non-volatile memory (e.g.: one time programmable read only memory (ROM) (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

According to an embodiment, the memory 110 may store at least one instruction or a computer program including instructions for controlling the electronic device 100.

According to an embodiment, the memory 110 may store various types of data received from an external device (e.g., a source device), an external storage medium (e.g., a USB), an external server (e.g., a webhard), etc. According to an embodiment, the memory 110 may be implemented as single memory that stores data generated in various operations according to the disclosure. However, according to another embodiment, the memory 110 may be implemented to include a plurality of memories that respectively store different types of data, or respectively store data generated in different steps.

Also, the memory 110 may store various types of data, programs, or applications for driving/controlling the electronic device 100. In particular, the memory 110 according to an embodiment of the disclosure may store token sets corresponding to each of a plurality of emotions 10.

Referring to FIG. 1, each of the plurality of emotions may include a neutral emotion 10-1, happiness 10-2, sadness 10-3, and anger 10-4.

However, this is merely an example, and each of the plurality of emotions may correspond to different emotions such as admiration, adoration, aesthetic appreciation, amusement, anxiety, awe, awkwardness, boredom, calmness, confusion, craving, disgust, empathetic pain, entrancement, envy, jealousy, thrill, excitement, fear, horror, interest, curiosity, joy, homesickness, nostalgia, romance, sadness, satisfaction, sexual desire, sympathy, triumph, etc.

According to an embodiment of the disclosure, the memory 110 (or, the style encoder A stored in the memory 110) may store token sets corresponding to each of the plurality of emotions 10, and the at least one processor 120 may identify one emotion among the plurality of emotions 10, and obtain a token set corresponding to the identified emotion. In the aforementioned embodiment, it was explained that various types of data is stored in external memory of the at least one processor 120, but it is obvious that at least some of the aforementioned data can be stored in internal memory of the at least one processor 120.

The at least one processor 120 controls the overall operations of the electronic device 100. Specifically, the at least one processor 120 may be connected with each component of the electronic device 100, and control the overall operations of the electronic device 100.

The at least one processor 120 may perform the operations of the electronic device 100 according to the various embodiments by executing the at least one instruction stored in the memory 110.

The at least one processor 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 120 may control one or a random combination of the other components of the electronic device, and perform an operation related to communication or data processing. The at least one processor 120 may execute one or more programs or instructions stored in the memory 110. For example, the at least one processor 120 may perform the method according to an embodiment of the disclosure by executing the one or more instructions stored in the memory 110.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 120 may be implemented as a single core processor including one core, or may be implemented as one or more multicore processors including a plurality of cores (e.g., multicores of the same kind or multicores of different kinds). In case the at least one processor 120 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

In particular, when a reference speech is received, the at least one processor 120 according to an embodiment of the disclosure may identify an emotion corresponding to the reference speech among the plurality of emotions.

The at least one processor 120 may input a token set corresponding to the identified emotion and the reference speech into the style encoder A (or, the style attention of the style encoder A), and obtain style information.

The at least one processor 120 may input a text and the style information into the decoder B, and synthesize and output a speech which corresponds to the text, and to which the emotion is reflected, and which has a similar style to the reference speech.

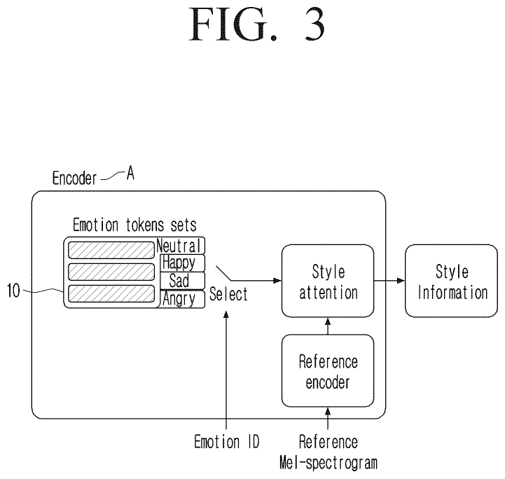

FIG. 3 is a diagram for illustrating style information obtained through a style encoder according to an embodiment of the disclosure.

The style encoder A according to an embodiment of the disclosure may include token sets corresponding to each of the plurality of emotions 10.

For example, if the style encoder A is trained by using training data to which the plurality of emotions are reflected (referred to as a plurality of sample reference speeches hereinafter) without dividing each of the plurality of emotions 10 (e.g., without classifying each of the plurality of emotions into different categories), there is a problem that a prosodic feature indicating an emotion (referred to as a token set corresponding to an emotion hereinafter) indicates an average prosodic feature (e.g., a prosodic feature of a speech to which a neutral emotion is reflected), or a prosodic feature indicating an emotion is overfitted to a prosodic feature of a specific emotion (e.g., joy).

According to an embodiment of the disclosure, the style encoder A may be trained to obtain token sets corresponding to each of the plurality of emotions 10 (i.e., divided into each of the plurality of emotions 10) by using the plurality of sample reference speeches.

A learning step (or, a training step) of the style encoder A according to an embodiment of the disclosure will be explained later.

According to an embodiment, if a reference speech is received in an inference step, the at least one processor 120 may obtain information on the reference speech. For example, if a reference speech in a mel-spectrogram form is received, the at least one processor 120 may input the reference speech into a reference encoder, and obtain reference embedding. For example, the at least one processor 120 may embed the mel-spectrogram in a fixed-length vector, and obtain reference embedding.

According to an embodiment, as a human sense of hearing does not receive all frequencies uniformly, a mel-spectrogram may include a spectrogram which converted a speech in a mel-scale to coincide with the human sense of hearing.

According to an embodiment of the disclosure, the at least one processor 120 may identify an emotion from a reference speech. For example, a reference speech may include an emotion identifier (ID), and the at least one processor 120 may identify an emotion corresponding to the reference speech by analyzing the reference speech.

The at least one processor 120 may include a token set corresponding to the identified emotion among the plurality of emotions. Here, the token set corresponding to the identified emotion may indicate a prosodic feature according to the identified emotion.

According to an embodiment of the disclosure, for obtaining a synthesized speech in a similar style to a reference speech, the at least one processor 120 may obtain style information by inputting reference embedding and a token set corresponding to an identified emotion into the style attention of the style encoder A.

For example, in the inference step of obtaining a synthesized speech through the style encoder A and the decoder B, the style attention of the style encoder A may obtain style information indicating a weighted sum of the style tokens based on similarity between each of the style tokens included in the token set corresponding to the identified emotion and the reference embedding, for obtaining a synthesized speech in a similar utterance style to the reference speech.

In the disclosure, a reference speech may include a speech (or, an instruction, etc.) indicating ‘a synthesized speech of which style is desired to be obtained.’

Referring to FIG. 3, depending on embodiments, the language of a speech uttered by a speaker to be synthesized and the language of a text (the phoneme in FIG. 1) may be different.

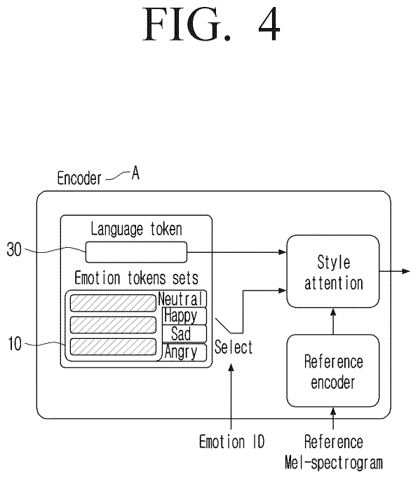

FIG. 4 is a diagram for illustrating a style encoder that outputs style information by using a token set corresponding to an emotion and a language token according to an embodiment of the disclosure.

According to an embodiment, the at least one processor 120 may identify a language based on a language look-up table, and obtain a language token corresponding to the identified language.

For example, as illustrated in FIG. 1, the at least one processor 120 may identify a language corresponding to a reference speech, and obtain a language token 30 corresponding to the identified language.

According to an embodiment of the disclosure, for obtaining a synthesized speech in a similar style to a reference speech, the at least one processor 120 may input reference embedding output by the reference encoder, a token set corresponding to an identified emotion, and a language token 30 indicating sound patterns of a language corresponding to the reference speech into the style attention of the style encoder A, and obtain style information.

For example, in the inference step of obtaining a synthesized speech through the style encoder A and the decoder B, the style attention of the style encoder A may, for obtaining a synthesized speech to which sound patterns of a language corresponding to the reference speech are reflected, and which has a similar utterance style to the reference speech, obtain style information indicating a weighted sum of the style tokens based on similarity between the language token 30 and each of the style tokens included in the token set corresponding to the identified emotion, and the reference embedding.

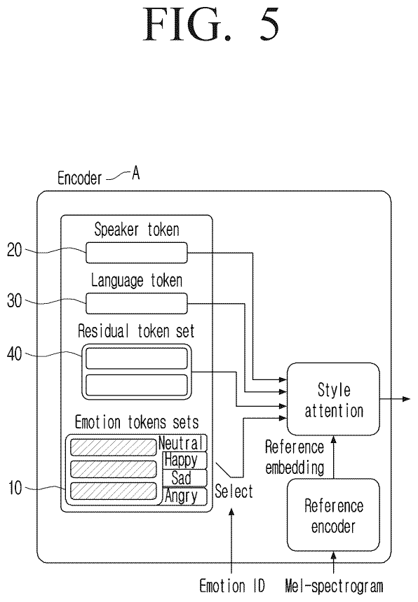

FIG. 5 is a diagram for illustrating a style encoder that outputs style information by using token sets corresponding to each of a plurality of emotions, a speaker token, a language token, and a residual token according to an embodiment of the disclosure.

According to an embodiment, the at least one processor 120 may identify a speaker corresponding to a reference speech (or, a mel-spectrogram) based on a speaker look-up table, and obtain a speaker token 20 corresponding to the identified speaker (speaker ID).

For example, if a speaker corresponding to a reference speech corresponds to a speaker token of at least one sample reference speech among the plurality of sample reference speeches which are the training data of the style encoder A, the at least one processor 120 may identify a speaker corresponding to the reference speech (or, the mel-spectrogram), and obtain a speaker token corresponding to the identified speaker (speaker ID).

According to an embodiment, the at least one processor 120 may obtain a speaker token 20 for obtaining a synthesized speech to which an utterance style according to the speaker of the reference speech is reflected more appropriately, and for obtaining a synthesized speech in a similar style to the reference speech, the at least one processor 120 may obtain style information by inputting the speaker token 20 indicating the utterance style of the speaker of the reference speech, reference embedding output by the reference encoder, and a token set corresponding to the identified emotion into the style attention of the style encoder A.

The at least one processor 120 according to an embodiment may obtain a residual token 40 in addition to the speaker token 20 indicating the utterance style of the speaker of the reference speech, and the language token 30 indicating sound patterns according to the language of the reference speech (or, the phonetic feature of the language corresponding to the reference speech).

The style encoder A according to an embodiment may obtain the residual token 40 indicating the rest (e.g., a noise) excluding the token set 10 indicating an emotion, the speaker token 20 indicating the utterance style of the speaker, and the language token 30 indicating the sound patterns according to the language, in each of the plurality of sample reference speeches which are the training data. For example, the style encoder A may obtain the residual token 40 indicating liveliness and naturalness in each of the plurality of sample reference speeches.

When a reference speech is received, the at least one processor 120 according to an embodiment may i) identify an emotion (or, select an emotion), and obtain the token set 10 corresponding to the identified emotion among the plurality of emotions, ii) obtain the speaker token 20 corresponding to the speaker of the reference speech, iii) obtain the language token 30 corresponding to the language of the reference speech, and iv) obtain the residual token 40.

The at least one processor 120 according to an embodiment may obtain style information by inputting i) the token set 10 corresponding to the identified emotion, ii) the speaker token 20, iii) the language token 30, and iv) the residual token 40, and v) reference embedding corresponding to the reference speech into the style attention of the style encoder A.

According to an embodiment, the at least one processor 120 may obtain style information by inputting at least one of i) the token set 10 corresponding to the identified emotion, ii) the speaker token 20, iii) the language token 30, or iv) the residual token 40, and v) reference embedding corresponding to the reference speech into the style attention of the style encoder A.

The at least one processor 120 according to an embodiment may obtain reference embedding by inputting a mel-spectrogram into the reference encoder, and obtain text embedding by inputting phonemes corresponding to a text into the text encoder.

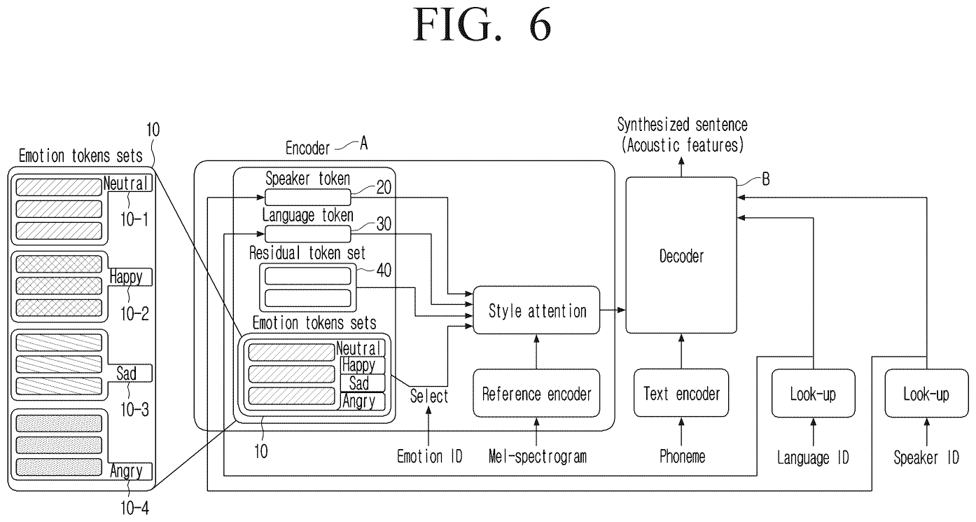

FIG. 6 is a diagram for illustrating training of a style encoder according to an embodiment of the disclosure.

Referring to FIG. 6, in a learning step (or, a training step), if a mel-spectrogram corresponding to at least one sample reference speech among the plurality of sample reference speeches which are training data is input, the style encoder A may obtain reference embedding corresponding to the mel-spectrogram by using the reference encoder.

According to an embodiment, the style encoder A may identify a speaker corresponding to at least one sample reference speech, and input the identified speaker (speaker ID) into a look-up embedding table, and obtain a speaker embedding vector.

According to an embodiment, the style encoder A may identify a language corresponding to at least one sample reference speech, and input the identified language (language ID) into the look-up embedding table, and obtain a language embedding vector.

According to an embodiment, the style encoder A may set a plurality of style tokens included in the token sets corresponding to each of the plurality of emotions as randomly initialized embedding vectors.

According to an embodiment, the style encoder A may set the residual token as the randomly initialized embedding vectors.

According to an embodiment, the style encoder A may be an unsupervised learning model that learned similarity between the token set 10 corresponding to an emotion identified based on at least one sample reference speech among the plurality of emotions, the speaker token 20 according to the speaker embedding vector, the language token 30 according to the language embedding vector, and the residual token 40, and the mel-spectrogram corresponding to the at least one sample reference speech.

For example, the style encoder A may learn each of the plurality of style tokens included in a token set of a target emotion (e.g., an emotion identified based on at least one sample reference speech among the plurality of emotions) by applying the attention to the reference embedding corresponding to the at least one sample reference speech.

For example, the style encoder A may learn each of the speaker token 20, the language token 30, and the residual token 40 by applying the attention to the reference embedding corresponding to the at least one sample reference speech.

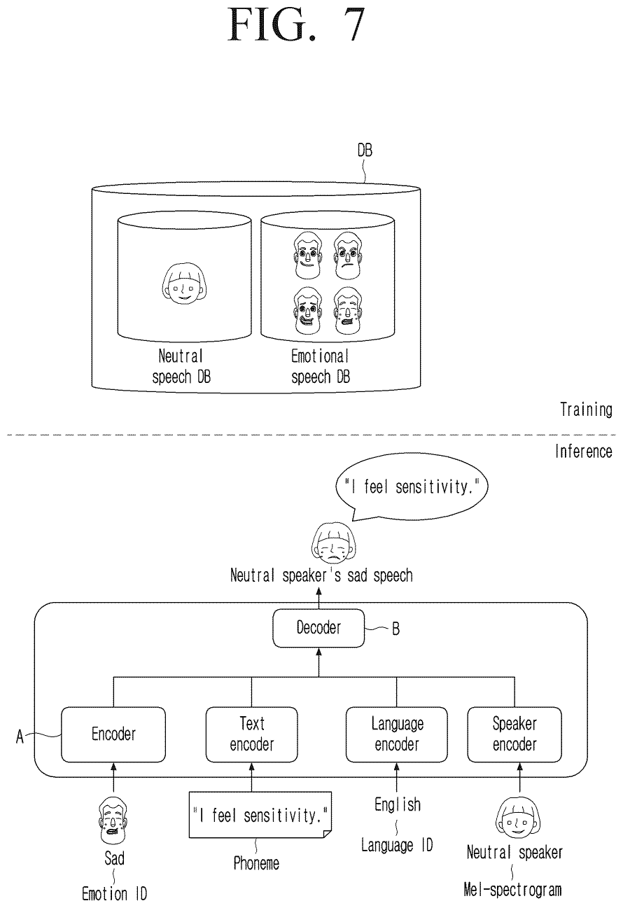

FIG. 7 is a diagram for illustrating a plurality of sample reference speeches and a synthesized speech according to an embodiment of the disclosure.

The upper part of FIG. 7 illustrates a plurality of sample reference speeches (the training step).

For example, the plurality of sample reference speeches may include sample reference speeches of a neutral emotion (the neutral speech DB in FIG. 7), and sample reference speeches of each of the plurality of emotions (the emotional speech DB in FIG. 7).

The lower part of FIG. 7 illustrates an electronic device 100 that obtains a synthesized speech through the style encoder A and the decoder B (the inference step).

According to an embodiment, if ‘I feel sensitive’ in English is received as a text, the at least one processor 120 may identify a language (language ID), and if a speaker to be synthesized is received, the at least one processor 120 may identify a speaker (speaker ID).

According to an embodiment, the at least one processor 120 may input phonemes corresponding to the text ‘I feel sensitive’ into the text encoder and obtain text embedding, and input the language (language ID) into the language encoder, and obtain the language token 30.

According to an embodiment, the at least one processor 120 may identify a speaker to be synthesized (e.g., the speaker (speaker ID) of the neutral speaker in FIG. 7).

According to an embodiment, the at least one processor 120 may identify an emotion corresponding to a reference speech among the plurality of emotions, and as illustrated in FIG. 7, when an emotion identifier (ID) is received, the at least one processor 120 may identify an emotion corresponding to the emotion ID among the plurality of emotions. For example, the at least one processor 120 may obtain a token set 10-3 corresponding to a sad emotion according to the emotion ID through the style encoder A.

According to an embodiment, the at least one processor 120 may obtain style information by inputting the reference embedding obtained by inputting a mel-spectrogram corresponding to the reference speech into the reference encoder, the token set 10-3 corresponding to a sad emotion, and the language token 30 into the style attention.

According to an embodiment, the decoder B may output a synthesized speech which corresponds to a text, and to which a sad emotion was transferred based on the style information.

For example, a synthesized speech output by the decoder B may have a similar utterance style to a speaker (e.g., a speaker ID) to be synthesized, and may correspond to ‘I feel sensitive’ of a sad emotion.

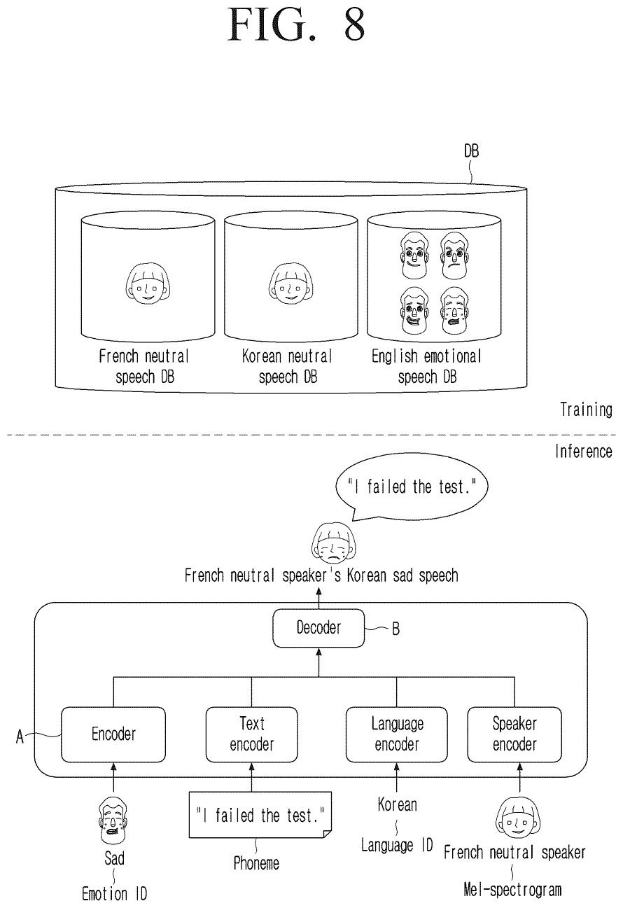

FIG. 8 is a diagram for illustrating a synthesized speech obtained through a decoder in a multi-language environment according to an embodiment of the disclosure.

The upper part of FIG. 8 illustrates a plurality of sample reference speeches (the training step).

For example, the plurality of sample reference speeches may include sample reference speeches in French of a neutral emotion (the French neutral speech DB in FIG. 8), sample reference speeches in Korean of a neutral emotion (the Korean neutral speech DB in FIG. 8), and sample reference speeches in English of each of the plurality of emotions (the English emotional speech DB in FIG. 8).

The lower part of FIG. 8 illustrates an electronic device 100 that obtains a synthesized speech through the style encoder A and the decoder B (the inference step).

According to an embodiment, the at least one processor 120 may receive a speaker to be synthesized (e.g., the neutral French speaker in FIG. 8), and receive ‘I failed the test’ in Korean as a text.

For example, as illustrated in FIG. 8, the at least one processor 120 may input phonemes corresponding to a text into the text encoder, and obtain text embedding.

For example, the at least one processor 120 may input ‘I failed the test’ in Korean into the text encoder and obtain text embedding, and input the language (language ID) into the language encoder and obtain language embedding (e.g., Korean).

According to an embodiment, as illustrated in FIG. 8, when an emotion identifier (emotion ID) is received, the at least one processor 120 may identify an emotion corresponding to the emotion ID among the plurality of emotions. For example, the at least one processor 120 may obtain a token set 10-3 corresponding to a sad emotion according to the emotion ID through the style encoder A.

According to an embodiment, the at least one processor 120 may obtain style information by inputting the reference embedding obtained by inputting a mel-spectrogram corresponding to the reference speech into the reference encoder, and the token set 10-3 corresponding to a sad emotion into the style attention.

According to an embodiment, the decoder B may output a synthesized speech which corresponds to a text, and to which a sad emotion was transferred based on the style information.

According to an embodiment, the decoder B may output a synthesized speech corresponding to a Korean text which has a similar utterance style to the neutral French speaker, and to which sound patterns of Korean are reflected, and to which a sad emotion was transferred.

For example, the synthesized speech output by the decoder B may correspond to ‘I failed the test’ of a sad emotion which has a similar utterance style to the speaker to be synthesized, and to which sound patterns of Korean are reflected. For example, the synthesized speech output by the decoder B is a voice of a speaker whose native language is French, and may correspond to ‘I failed the test’ of a sad emotion.

As illustrated in the upper part of FIG. 8, the plurality of sample reference speeches which are the training data of the style encoder A do not include the French sample reference speeches of each of the plurality of emotions (e.g., the French emotional speech DB), and the Korean sample reference speeches of each of the plurality of emotions (e.g., the Korean emotional speech DB), etc. (i.e., include only the English sample reference speeches of each of the plurality of emotions), but the style encoder A and the decoder B may generate a synthesized speech which corresponds to a text in Korean or French other than English, and to which an emotion was transferred.

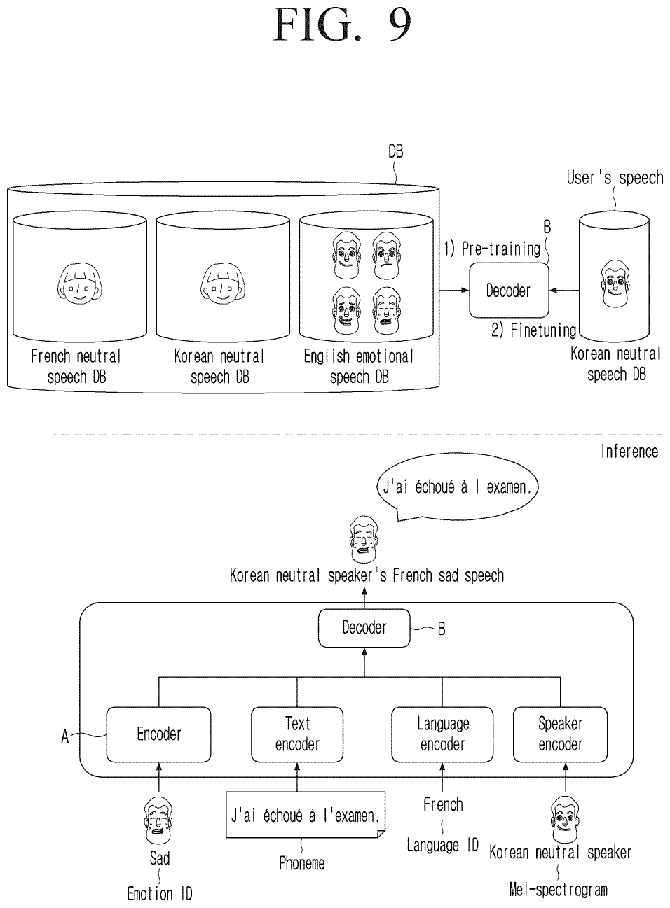

FIG. 9 is a diagram for illustrating a decoder that outputs a synthesized speech including an utterance feature of a user according to an embodiment of the disclosure.

The upper part of FIG. 9 illustrates a plurality of sample reference speeches (the training step).

For example, the plurality of sample reference speeches may include sample reference speeches of the speaker 1 (e.g., a female neutral French speaker) (the French female neutral speech DB in FIG. 9), sample reference speeches of the speaker 2 (e.g., a female neutral Korean speaker) (the Korean female neutral speech DB in FIG. 9), and sample reference speeches of the speaker 3 (e.g., English speakers of each of the plurality of emotions) (the English emotional speech DB in FIG. 9).

For example, the style encoder A may include the speaker 1 (e.g., a female French speaker), the speaker 2 (e.g., a female Korean speaker), or the speaker 3 (e.g., English speakers), etc. as the speaker token 20, and include the language 1 (e.g., French), the language 2 (e.g., Korean), and the language 3 (e.g., English), etc. as the language token 30, and include the token set 10 corresponding to each of the plurality of emotions.

According to an embodiment, the user of the electronic device 100 may correspond to the speaker 4 (e.g., a male Korean speaker) other than the speaker 1 to the speaker 3.

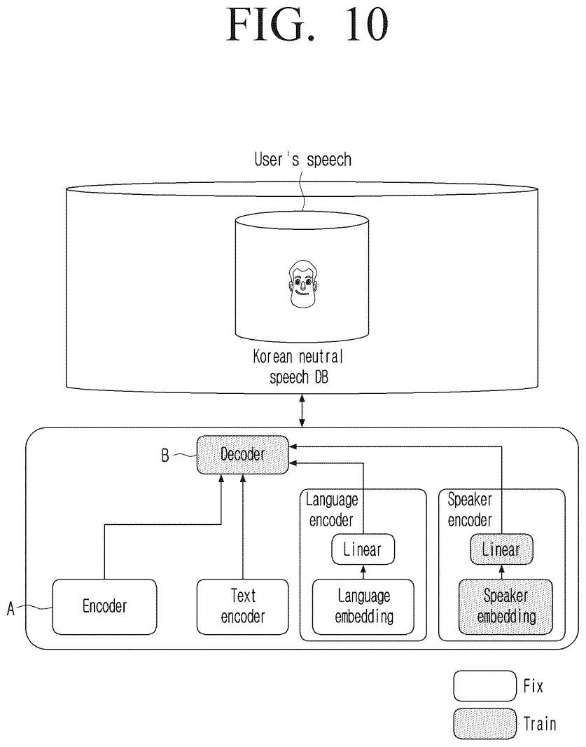

According to an embodiment of the disclosure, the electronic device 100 may fine-tune the style encoder A by receiving the voice of the user (i.e., the speaker 4). Detailed explanation in this regard will be described later with reference to FIG. 10.

The lower part of FIG. 9 illustrates the electronic device 100 that obtains a synthesized speech through the style encoder A and the decoder B (the inference step).

According to an embodiment, the at least one processor 120 may receive a speaker to be synthesized (e.g., the speaker 4 (e.g., a male neutral Korean speaker), and receive ‘J'ai éhoé à l'examen.’ in French as a text.

For example, the at least one processor 120 may input ‘J'ai éhoé à l'examen.’ in French into the text encoder and obtain text embedding, and input the language (language ID) into the language encoder and obtain language embedding (e.g., French).

According to an embodiment, as illustrated in FIG. 10, when an emotion identifier (emotion ID) is received, the at least one processor 120 may identify an emotion corresponding to the emotion ID among the plurality of emotions. For example, the at least one processor 120 may obtain a token set 10-3 corresponding to a sad emotion according to the emotion ID through the style encoder A.

According to an embodiment, the at least one processor 120 may input a mel-spectrogram corresponding to the reference speech, and the token set 10-3 corresponding to a sad emotion into the style attention, and obtain style information. According to an embodiment, the decoder B may output a synthesized speech which corresponds to a text, and to which a sad emotion was transferred based on the style information.

According to an embodiment, the decoder B may output a synthesized speech corresponding to a French text (e.g., ‘J'ai éhoé à l'examen.’) which has a similar utterance style to the neutral male Korean speaker, and to which sound patterns of French are reflected, and to which a sad emotion was transferred.

According to an embodiment, if the speaker (e.g., the speaker 4 (e.g., a male Korean speaker) does not correspond to the speaker token (e.g., the speaker 1 (e.g., a female French speaker), the speaker 2 (e.g., a female Korean speaker), or the speaker 3 (e.g., English speakers)) of each of the plurality of sample reference speeches which are the training data of the style encoder A, the at least one processor 120 may fine-tune the speech synthesis device such that the utterance feature of the speaker of the reference speech is included in the synthesis speech, based on the speech uttered by the speaker of the reference speech (or, the user of the electronic device 100).

FIG. 10 is a diagram for illustrating fine-tuning of a speech synthesis device according to an embodiment of the disclosure.

Referring to FIG. 10, if the speaker to be synthesized (or, the user of the electronic device 100) does not correspond to the speaker token 20 included in the style encoder A, the at least one processor 120 may guide the speaker to be synthesized to utter an additional speech, for obtaining a synthesized speech to which the utterance feature of the speaker of the reference speech is reflected more appropriately.

For example, the at least one processor 120 may receive an additional speech (the user's speech in FIG. 10) by guiding the speaker to be synthesized to utter a predetermined sentence.

If the speaker to be synthesized utters the predetermined sentence, the at least one processor 120 may fine-tune the decoder B and the speaker encoder based on the received additional speech (i.e., the predetermined sentence uttered by the speaker of the reference speech), and include the utterance feature of the speaker of the reference speech in the synthesized speech output by the decoder B.

Returning to FIG. 8, the plurality of sample reference speeches may include sample reference speeches of the speaker 1 (e.g., a neutral French speaker) (the French neutral speech DB in FIG. 8), sample reference speeches of the speaker 2 (e.g., a neutral Korean speaker) (the Korean neutral speech DB in FIG. 8), and sample reference speeches of the speaker 3 (e.g., English speakers of each of the plurality of emotions) (the English emotional speech DB in FIG. 8).

For example, the style encoder A may include the speaker 1 (e.g., a French speaker), the speaker 2 (e.g., a Korean speaker), or the speaker 3 (e.g., English speakers), etc. as the speaker token 20, and include the language 1 (e.g., French), the language 2 (e.g., Korean), and the language 3 (e.g., English), etc. as the language token 30, and include the token set 10 corresponding to each of the plurality of emotions.

According to an embodiment, the speaker to be synthesized may correspond to any one of the speaker 1 to the speaker 3.

According to an embodiment, if the speaker to be synthesized corresponds to any one of the speakers of each of the plurality of sample reference speeches, the at least one processor 120 may obtain the speaker token 20 corresponding to the speaker of the reference speech.

According to an embodiment, the at least one processor 120 may obtain style information by inputting the reference embedding obtained by inputting a mel-spectrogram corresponding to the reference speech into the reference encoder, and the token set 10-3 corresponding to a sad emotion into the style attention.

According to an embodiment, the decoder B may output a synthesized speech which corresponds to a text, and to which the utterance style of the speaker to be synthesized is reflected more appropriately based on the style information, and to which a sad emotion was transferred.

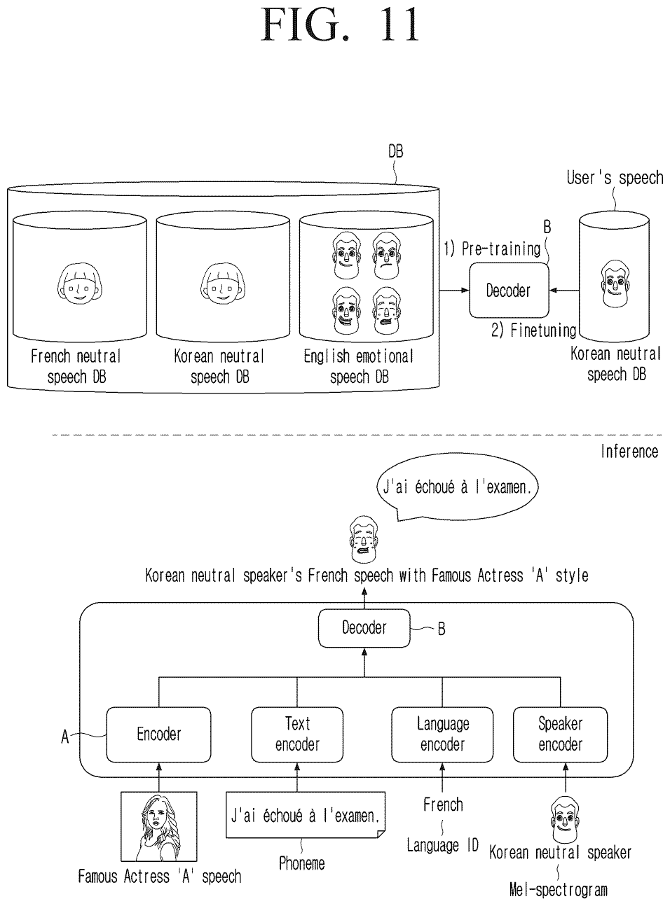

FIG. 11 is a diagram for illustrating a decoder that outputs a synthesized speech in consideration of a speaker of a reference speech after fine-tuning of the decoder, and a speaker token corresponding to each of a plurality of sample reference speeches according to an embodiment of the disclosure.

The fine-tuned decoder B′ illustrated in FIG. 9 may output a synthesized speech to which the utterance feature (e.g., the voice, etc.) of the user of the electronic device 100 is reflected, based on an additional speech (the user's speech in FIG. 10) received from the user of the electronic device 100 (e.g., the speaker 4 (e.g., a male Korean speaker)).

The lower part of FIG. 11 illustrates the electronic device 100 that obtains a synthesized speech through the fine-tuned decoder B′ (the inference step).

According to an embodiment, the at least one processor 120 may receive a reference speech, and receive ‘J'ai éhoé à l'examen.’ in French as a text. Here, the speaker of the reference speech may be the speaker 5 (e.g., a famous celebrity ‘A’), but not the speaker 1 to the speaker 3, and the user of the electronic device 100 (e.g., the speaker of an additional speech (the user's speech in FIG. 10) used for fine-tuning, the speaker 4) who are the speakers of each of the plurality of sample reference speeches, which are the training data of the style encoder A.

According to an embodiment, the at least one processor 120 may obtain style information by inputting a mel-spectrogram corresponding to the reference speech, the token set 10 corresponding to an emotion according to the emotion ID, and the language token 30 into the style attention.

According to an embodiment, the fine-tuned decoder B′ may output a synthesized speech which corresponds to a text, and to which an emotion was transferred based on the style information.

For example, the fine-tuned decoder B′ may output a synthesized speech which corresponds to a text, and includes the utterance feature of the user (e.g., the speaker 4) (corresponds to the voice of the user) according to speaker embedding corresponding to the speaker (speaker ID) to be synthesized, but to which the utterance style (e.g., including the tone, the accent, the rhythm, etc.) of the speaker of the reference speech (e.g., the speaker 5) is reflected according to a mel-spectrogram, and to which an identified emotion was transferred.

For example, the fine-tuned decoder B′ may output a synthesized speech corresponding to a French text (e.g., ‘J'ai éhoé à l'examen.’), which is the voice of the user of the electronic device 100, and to which the utterance style of the famous celebrity ‘A’ is reflected, and to which an emotion was transferred and a prosodic feature (e.g., the pitch (e.g., high and low), the length (e.g., speed), and the size (e.g., strong and weak) of a sound) was transferred.

According to an embodiment, if the speaker to be synthesized (e.g., the speaker 4 (e.g., a male Korean speaker)) does not correspond to the speaker token (e.g., the speaker 1 (e.g., a female French speaker), the speaker 2 (e.g., a female Korean speaker), or the speaker 3 (e.g., English speakers)) of each of the plurality of sample reference speeches which are the training data of the style encoder A, the at least one processor 120 may fine-tune the decoder B such that the utterance feature of the speaker of the reference speech is included in the synthesis speech, based on the speech uttered by the speaker of the reference speech (or, the user of the electronic device 100).

Functions related to artificial intelligence according to the disclosure are operated through the at least one processor 120 and the memory 110 of the electronic device 100.

The at least one processor 120 may include at least one of a central processing unit (CPU), a graphic processing unit (GPU), or a neural processing unit (NPU), but is not limited to the aforementioned examples of processors.

A CPU is a generic-purpose processor that can perform not only general operations but also artificial intelligence operations, and it can effectively execute a complex program through a multilayer cache structure. A CPU is advantageous for a serial processing method that enables a systemic linking between the previous calculation result and the next calculation result through sequential calculations. A generic-purpose processor is not limited to the aforementioned examples excluding cases wherein it is specified as the aforementioned CPU.

A CPU is a processor for mass operations such as a floating point operation used for graphic processing, etc., and it can perform mass operations in parallel by massively integrating cores. In particular, a GPU may be advantageous for a parallel processing method such as a convolution operation, etc. compared to a CPU. Also, a GPU may be used as a co-processor for supplementing the function of a CPU. A processor for mass operations is not limited to the aforementioned examples excluding cases wherein it is specified as the aforementioned GPU.

An NPU is a processor specialized for an artificial intelligence operation using an artificial neural network, and it can implement each layer constituting an artificial neural network as hardware (e.g., silicon), Here, the NPU is designed to be specialized according to the required specification of a company, and thus it has a lower degree of freedom compared to a CPU or a GPU, but it can effectively process an artificial intelligence operation required by the company. Meanwhile, as a processor specialized for an artificial intelligence operation, an NPU may be implemented in various forms such as a tensor processing unit (TPU), an intelligence processing unit (IPU), a vision processing unit (VPU), etc. An artificial intelligence processor is not limited to the aforementioned examples excluding cases wherein it is specified as the aforementioned NPU.

Also, the at least one processor 120 may be implemented as a system on chip (SoC). Here, in the SoC, the memory, and a network interface such as a bus for data communication between the processor and the memory, etc. may be further included other than the one or plurality of processors.

In case a plurality of processors are included in the system on chip (SoC) included in the electronic device 100, the electronic device 100 may perform an operation related to artificial intelligence (e.g., an operation related to learning or inference of the artificial intelligence model) by using some processors among the plurality of processors. For example, the electronic device 100 may perform an operation related to artificial intelligence by using at least one of a GPU, an NPU, a VPU, a TPU, or a hardware accelerator specified for artificial intelligence operations such as a convolution operation, a matrix product operation, etc. among the plurality of processors. However, this is merely an example, and the electronic device 100 can obviously process an operation related to artificial intelligence by using the generic-purpose processor such as a CPU, etc.

Also, the electronic device 100 may perform operations for functions related to artificial intelligence by using a multicore (e.g., a dual core, a quad core, etc.) included in one processor. In particular, the electronic device 100 may perform artificial intelligence operations such as a convolution operation, a matrix product operation, etc. in parallel by using the multicore included in the processor.

The one or plurality of processors perform control to process input data according to pre-defined operation rules or an artificial intelligence model stored in the memory 110. The pre-defined operation rules or the artificial intelligence model are characterized in that they are made through learning.

Here, being made through learning means that a learning algorithm is applied to a plurality of training data, and pre-defined operation rules or an artificial intelligence model having desired characteristics are thereby made. Such learning may be performed in a device itself wherein artificial intelligence is performed according to the disclosure, or through a separate server/system.

An artificial intelligence model may consist of a plurality of neural network layers. At least one layer has at least one weight value, and performs an operation of the layer through an operation result of the previous layer and at least one defined operation. As examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), generative adversarial networks (GAN), an NeRF, deep Q-networks, and a Transformer, but the neural network in the disclosure is not limited to the aforementioned examples excluding specified cases.

A learning algorithm is a method of training a specific subject device (e.g., a robot) by using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

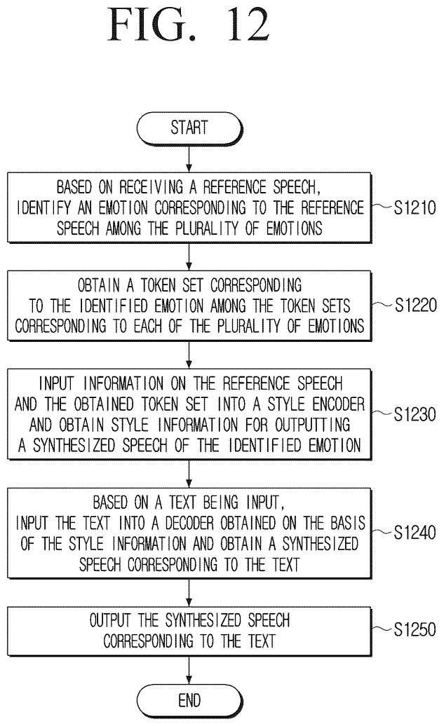

FIG. 12 is a flow chart for illustrating a control method for an electronic device according to an embodiment of the disclosure.

In a control method for an electronic device according to an embodiment of the disclosure, based on receiving a reference speech, an emotion corresponding to the reference speech among a plurality of emotions is identified in the operation S1210.

Then, a token set corresponding to the identified emotion among token sets corresponding to each of the plurality of emotions is obtained in the operation S1220.

Then, information on the reference speech and the obtained token set are input into a style encoder and style information for outputting a synthesized speech of the identified emotion is obtained in the operation S1230.

Then, based on a text being input, the text is input into a decoder obtained on the basis of the style information and a synthesized speech corresponding to the text is obtained in the operation S1240.

Then, the synthesized speech corresponding to the text is output in the operation S1250.

The information on the reference speech may include reference embedding, and the style encoder may, based on similarity between at least one style token included in the obtained token set and the reference embedding, output the style information including style embedding indicating a weighted sum of the at least one style token.

The control method according to an embodiment of the disclosure may further include inputting a mel-spectrogram corresponding to the reference speech into a reference encoder and obtaining the reference embedding, and inputting phonemes corresponding to the text into a text encoder and obtaining text embedding.

The operation S1210 of identifying an emotion according to an embodiment may include, based on receiving an emotion identifier (ID), identifying the emotion corresponding to the emotion ID among the plurality of emotions.

The style encoder may be an unsupervised learning model that learned similarity between sample reference embedding corresponding to at least one sample reference speech among a plurality of sample reference speeches and at least one style token included in a token set corresponding to the emotion of the at least one sample reference speech.

The control method according to an embodiment may further include obtaining a language token, a speaker token, and a residual token corresponding to the at least one sample reference speech, and the style encoder may be an unsupervised learning model that learned similarity between the sample reference embedding corresponding to the at least one sample reference speech and the at least one style token, the language token, the speaker token, and the residual token included in the token set corresponding to the emotion of the at least one sample reference speech.

The operation S1230 of obtaining the style information according to an embodiment may include, based on the language of the reference speech corresponding to the language token of the at least one sample reference speech, inputting the at least one style token and the language token included in the token set corresponding to the emotion of the reference speech into the style encoder and obtaining the style information.

The operation S1230 of obtaining the style information according to an embodiment may include, based on a speaker to be synthesized corresponding to the speaker token of the at least one sample reference speech, inputting the at least one style token and the speaker token included in the token set corresponding to the emotion of the reference speech into the encoder and obtaining the style information.

The control method according to an embodiment may further include receiving an uttered speech of a user, and based on the received uttered speech, fine-tuning the decoder such that the synthesized speech corresponding to the text output by the decoder includes an utterance feature of the user.

The at least one style token included in the obtained token set according to an embodiment may correspond to at least one of prosodic features of a speech.

Meanwhile, the various embodiments of the disclosure can obviously be applied to electronic devices in various types.

Meanwhile, the aforementioned various embodiments may be implemented in a recording medium that can be read by a computer or a device similar to a computer, by using software, hardware, or a combination thereof. In some cases, the embodiments described in this specification may be implemented as a processor itself. According to implementation by software, the embodiments such as procedures and functions described in this specification may be implemented as separate software modules. Each of the software modules can perform one or more functions and operations described in this specification.

Meanwhile, computer instructions for performing processing operations of an electronic device according to the aforementioned various embodiments of the disclosure may be stored in a non-transitory computer-readable medium. Computer instructions stored in such a non-transitory computer-readable medium make the processing operations at an electronic device according to the aforementioned various embodiments performed by a specific machine, when the instructions are executed by the processor of the specific machine.

A non-transitory computer-readable medium refers to a medium that stores data semi-permanently, and is readable by machines, but not a medium that stores data for a short moment such as a register, a cache, and memory. As specific examples of a non-transitory computer-readable medium, there may be a compact disk (CD), a digital versatile disc (DVD), a hard disc, a blue-ray disc, a USB, a memory card, a ROM and the like.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs and a plurality of token sets corresponding to each of a plurality of emotions; and
one or more processors one or more processors communicatively coupled to the memory,
wherein the one or more computer programs include computer-executable instructions that, when executed by the one or more processors individually or collectively, cause the electronic device to:
based on receiving a reference speech, identify an emotion corresponding to the reference speech among the plurality of emotions,
obtain a token set corresponding to the identified emotion among the plurality of token sets stored in the memory,
input information on the reference speech and the obtained token set into a style encoder and obtain style information for outputting a synthesized speech of the identified emotion,
based on a text being input, input the text into a decoder obtained on the basis of the style information and obtain a synthesized speech corresponding to the text, and
output the synthesized speech corresponding to the text.

2. The electronic device of claim 1,
wherein the information on the reference speech includes reference embedding, and
wherein the style encoder is configured to:
based on similarity between at least one style token included in the obtained token set and the reference embedding, output the style information including style embedding indicating a weighted sum of the at least one style token.

3. The electronic device of claim 2, wherein the one or more computer programs further include computer-executable instructions that, when executed by the one or more processors individually or collectively, cause the electronic device to:
input a mel-spectrogram corresponding to the reference speech into a reference encoder and obtain the reference embedding, and
input phonemes corresponding to the text into a text encoder and obtain text embedding.

4. The electronic device of claim 1, wherein the one or more computer programs further include computer-executable instructions that, when executed by the one or more processors individually or collectively, cause the electronic device to:
based on receiving an emotion identifier (ID), identify the emotion corresponding to the emotion ID among the plurality of emotions.

5. The electronic device of claim 1, wherein the style encoder is an unsupervised learning model that learned similarity between sample reference embedding corresponding to at least one sample reference speech among a plurality of sample reference speeches and at least one style token included in a token set corresponding to the emotion of the at least one sample reference speech.

6. The electronic device of claim 5,
wherein the one or more computer programs further include computer-executable instructions that, when executed by the one or more processors individually or collectively, cause the electronic device to:
obtain a language token, a speaker token, and a residual token corresponding to the at least one sample reference speech, and
wherein the style encoder is an unsupervised learning model that learned similarity between the sample reference embedding corresponding to the at least one sample reference speech and the at least one style token, the language token, the speaker token, and the residual token included in the token set corresponding to the emotion of the at least one sample reference speech.

7. The electronic device of claim 6, wherein the one or more computer programs further include computer-executable instructions that, when executed by the one or more processors individually or collectively, cause the electronic device to:
based on a language of the reference speech corresponding to the language token of the at least one sample reference speech, input the at least one style token and the language token included in the token set corresponding to the emotion of the reference speech into the style encoder and obtain the style information.

8. The electronic device of claim 6, wherein the one or more computer programs further include computer-executable instructions that, when executed by the one or more processors individually or collectively, cause the electronic device to:
based on a speaker to be synthesized corresponding to the speaker token of the at least one sample reference speech, input the at least one style token and the speaker token included in the token set corresponding to the emotion of the reference speech into the encoder and obtain the style information.

9. The electronic device of claim 1, wherein the one or more computer programs further include computer-executable instructions that, when executed by the one or more processors individually or collectively, cause the electronic device to:
receive an uttered speech of a user; and
based on the received uttered speech, fine-tune the decoder such that the synthesized speech corresponding to the text output by the decoder includes an utterance feature of the user.

10. The electronic device of claim 2, wherein the at least one style token included in the obtained token set corresponds to at least one of prosodic features of a speech.

11. A control method performed by an electronic device, the control method comprising:
based on receiving a reference speech, identifying an emotion corresponding to the reference speech among a plurality of emotions;
obtaining a token set corresponding to the identified emotion among token sets corresponding to each of the plurality of emotions;
inputting information on the reference speech and the obtained token set into a style encoder and obtaining style information for outputting a synthesized speech of the identified emotion;
based on a text being input, inputting the text into a decoder obtained on the basis of the style information and obtaining a synthesized speech corresponding to the text; and
outputting the synthesized speech corresponding to the text.

12. The control method of claim 11,
wherein the information on the reference speech includes reference embedding, and
wherein the style encoder is configured to:
based on similarity between at least one style token included in the obtained token set and the reference embedding, output the style information including style embedding indicating a weighted sum of the at least one style token.

13. The control method of claim 12, wherein the control method further comprises:
inputting a mel-spectrogram corresponding to the reference speech into a reference encoder and obtaining the reference embedding; and
inputting phonemes corresponding to the text into a text encoder and obtaining the text embedding.

14. The control method of claim 11, wherein the identifying the emotion comprises:
based on receiving an emotion identifier (ID), identifying the emotion corresponding to the emotion ID among the plurality of emotions.

15. The control method of claim 11, wherein the style encoder is an unsupervised learning model that learned similarity between sample reference embedding corresponding to at least one sample reference speech among a plurality of sample reference speeches and at least one style token included in a token set corresponding to the emotion of the at least one sample reference speech.

16. The control method of claim 15, wherein the control method further comprises:
obtaining a language token, a speaker token, and a residual token corresponding to the at least one sample reference speech, and
based on a language of the reference speech corresponding to the language token of the at least one sample reference speech, inputting the at least one style token and the language token included in the token set corresponding to the emotion of the reference speech into the style encoder and obtain the style information,
wherein the style encoder is an unsupervised learning model that learned similarity between the sample reference embedding corresponding to the at least one sample reference speech and the at least one style token, the language token, the speaker token, and the residual token included in the token set corresponding to the emotion of the at least one sample reference speech.

17. The control method of claim 11, wherein the control method further comprises:
receiving an uttered speech of a user; and
based on the received uttered speech, fine-tuning the decoder such that the synthesized speech corresponding to the text output by the decoder includes an utterance feature of the user.

18. The control method of claim 12, wherein the at least one style token included in the obtained token set corresponds to at least one of prosodic features of a speech.

19. One or more non-transitory computer-readable storage media storing one or more computer programs including computer-executable instructions that, when executed by one or more processors of an electronic device individually or collectively, cause the electronic device to perform operations, the operations comprising:
based on receiving a reference speech, identifying an emotion corresponding to the reference speech among a plurality of emotions;
obtaining a token set corresponding to the identified emotion among token sets corresponding to each of the plurality of emotions;
inputting information on the reference speech and the obtained token set into a style encoder and obtaining style information for outputting a synthesized speech of the identified emotion;
based on a text being input, inputting the text into a decoder obtained on the basis of the style information and obtaining a synthesized speech corresponding to the text; and
outputting the synthesized speech corresponding to the text.

20. The one or more non-transitory computer-readable storage media of claim 19, the operations further comprising:
inputting a mel-spectrogram corresponding to the reference speech into a reference encoder and obtaining the reference embedding; and
inputting phonemes corresponding to the text into a text encoder and obtaining the text embedding.
